(19) United States
(12) Patent Application Publication
(10) Pub. No.: US 2004/0071197 A1
(43) Pub. Date: Apr. 15, 2004

(54) Modified PN code tracking loop for direct-sequence spread-spectrum communication over arbitrarily correlated multipath fading channels

(76) Inventor: Jia-Chin Lin, Nan-Tou (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/267,635

(22) Filed: Oct. 10, 2002

(51) Int. Cl. H04B 1/707

(52) U.S. Cl. 375/148; 375/149; 375/150

(57) ABSTRACT

A modified fully digital pseudonoise code tracking loop is proposed in this invention for direct-sequence spread-spectrum communication. By taking advantage of the inherent diversity, a modified code tracking loop is embedded into a RAKE receiver in order to avoid problems caused by unstable locked points of error signals. Such unsteadiness of locked points often occurs with a conventional code tracking loop because the error signals may be randomly biased by multipath fading. Thus, a robust pull-in capability can be provided over a time-variant fading channel where multiple propagation paths are arbitrarily correlated. Furthermore, an effective multipath interference regeneration and cancellation technique is also proposed to improve the error characteristics of the proposed technique. Analytical expressions of the error characteristics and error signals are derived and then confirmed by means of extensive computer simulation results. In addition, several simulation results for the timing jitter and the mean time to lose lock are also presented in this invention. Very attractive behaviors obtained using the proposed technique are verified.

### BACKGROUND OF THE INVENTION

SYNCHRONIZATION of a locally generated despreading sequence with respect to a pseudonoise (PN) sequence carried by an incoming signal, which is modulated by information-bearing symbols and corrupted by noise and channel impairments, is one of the most important functions performed in the receiver of a direct-sequence spread-spectrum (DS/SS) system. Only when such synchronization is achieved can the well-known advantages of DS/SS, such as interference rejection, anti-jam performance, and better spectral utilization, be attained. Such synchronization is often accomplished in two stages: an acquisition stage, which brings the incoming sequence and the locally generated sequence into coarse alignment, followed by a tracking stage, which ensures that such alignment is maintained throughout the following detection processes. Moreover, a good code tracking loop can also effectively reduce the severity of the various problems caused by timing errors and thus improve the information detection performance.

### SUMMARY OF THE INVENTION

Substantial efforts have focused on the tracking problem for spread-spectrum communication, though most of the analyses have been conducted in the context of analog implementation and additive white Gaussian noise (AWGN) channels. However, very often, frequency-selective fading in addition to AWGN can seriously harm the tracking capabilities of conventional code tracking loops. The joint estimators for interference, multipath effects, and code delay based on the extended Kalman filter (EKF) can effectively deal with multipath effects in advance. However, since DS/SS wireless communication systems usually operate in very noisy environments, it has been found that the Kalman filter or recursive least squares (RLS) algorithms, in practice, provide no superiority at all, even after taking advantage of heavier computational loads [i.e.,O(N²)] and higher processing rates (i.e., twice the chip rate). Actually, any error in the estimate of the number of resolvable channel paths may completely change the functions of the EKF. In addition, a new code tracking loop and a modified technique with multipath interference cancellation have been proposed. However, they were also designed based on analog implementation technologies; therefore, not only are they difficult to realize but also the tap spacing cannot be adjusted at all to improve the performance of the diversity combining operation. In addition, no results for error signals and error characteristics have evidently been presented to validate the pull-in capabilities. On the other hand, to reduce the cost and/or complexity of SS user terminals to a level comparable with that of traditional frequency- or time-division multiple-access terminals, fully digital implementation of modems is highly desired and undoubtedly necessary.

In this invention, a fully digital, non-coherent, modified code tracking loop is proposed, which can operate on bandlimited DS/SS systems over frequency-selective fading channels. The modified code tracking loop, assisted by central-branch correlation, is embedded into the RAKE receiver in the proposed technique. By taking advantage of the central-branch correlation, the error characteristic obtained on each RAKE finger can be kept within one chip duration; thus, the kind of self-interference that was encountered in previous works can be effectively reduced. By exploiting the inherent diversity using maximum ratio combining (MRC) and multipath interference cancellation (MPIC), the proposed technique can avoid unsteadiness in the locked points of the error signals and, thus, provides an improved error characteristic. It is proven that the error signals obtained using the proposed technique are definitely odd-symmetric with respect to the common locked point over arbitrarily correlated multipath fading channels. Furthermore, very attractive improvements obtained using the proposed technique in terms of timing jitter and mean time to lose lock (MTLL) are verified here.

### BRIEF DESCRIPTION OF THE DRAWINGS

FIG. 1. The proposed modified code tracking loop.

FIG. 2. The shapes of S₁(ε), S₂(ε), and S₃(ε).

FIG. 3. (a) The residual cross correlation detected on the preceding finger.

FIG. 3. (Continued.) (b) The desired error characteristic detected on the given finger.

FIG. 3. Continued.(c) The residual cross correlation detected on the succeeding finger.

FIG. 3. Continued.(d) The desired error characteristic and residual cross correlation.

FIG. 3. Continued.(e) The effective error characteristic.

FIG. 4. Comparison of the error characteristics (i.e., long-time averages of the expected error signals) of PN code tracking loops.

FIG. 5. Short-time averages of the error signals of MCTL.

FIG. 6. Short-time averages of the error signals of MCTL/MPIC.

FIG. 7. Short-time averages of the error signals of EL.

FIG. 8. Short-time averages of the error signals of EL/MPIC.

FIG. 9. The simulation results of mean-squared timing errors obtained using the proposed techniques when n=16, n=32, and n=64.

FIG. 10. The simulation results of mean time to lose lock obtained using the proposed techniques when n=16, n=32, and n=64.

### DETAILED DESCRIPTION OF THE PREFERRED EMBODIMENT

### 1. Channel Model

Much research on diversity combining of a RAKE receiver has been done by taking advantage of various channel models and a variety of analytical techniques. A discrete-time multi-path channel model has been used, where each multi-path component is assumed to be separated wider than the chip duration so that the signals received at each tap are considered to be independent of one another. A tapped-delay-line (TDL) model has also been used based on the assumption that the bandwidth of the transmitted signals is narrower than or equal to the chip rate. In addition, a continuous-time multipath channel model has been employed to evaluate the performance of a RAKE receiver by taking into consideration the correlations between the signals received on different fingers of the RAKE receiver.

For a wide-band signal transmitted through a frequency-selective fading channel, the signature duration is, in general, much shorter than the coherence time of the channel. Thus, the channel varies slowly, and its characteristics can be measured accurately. The bandwidth of each signature waveform is therefore much wider than the coherence bandwidth of the channel, and the frequency-selective fading channel is very often represented as a TDL with tap spacing 1/B_{w} and tap weight coefficients given as zero-mean complex-valued stationary Gaussian random processes. The number of resolvable paths for each user is usually estimated as └B_{w}Tₘ┘+1, where Tₘ is channel multipath spread and └x┘ is the largest integer that is less than or equal to x. With this model, the equivalent low-pass time-varying impulse response of the wide-sense stationary channel with uncorrelated scattering can be represented as

$${h}_{c} ( τ , t ) = {\sum }_{l = 0}^{L} {a}_{l} ( t ) δ ( τ + {lT}_{c} )$$

where h_{c}(τ,t) denotes the impulse response at delay τ and at time instant t, αₗ(t), represents the time-varying complex-valued tap weights with Rayleigh distributed magnitudes and uniformly distributed phases, and the number of resolvable paths is (L+1).

### 2. System Description

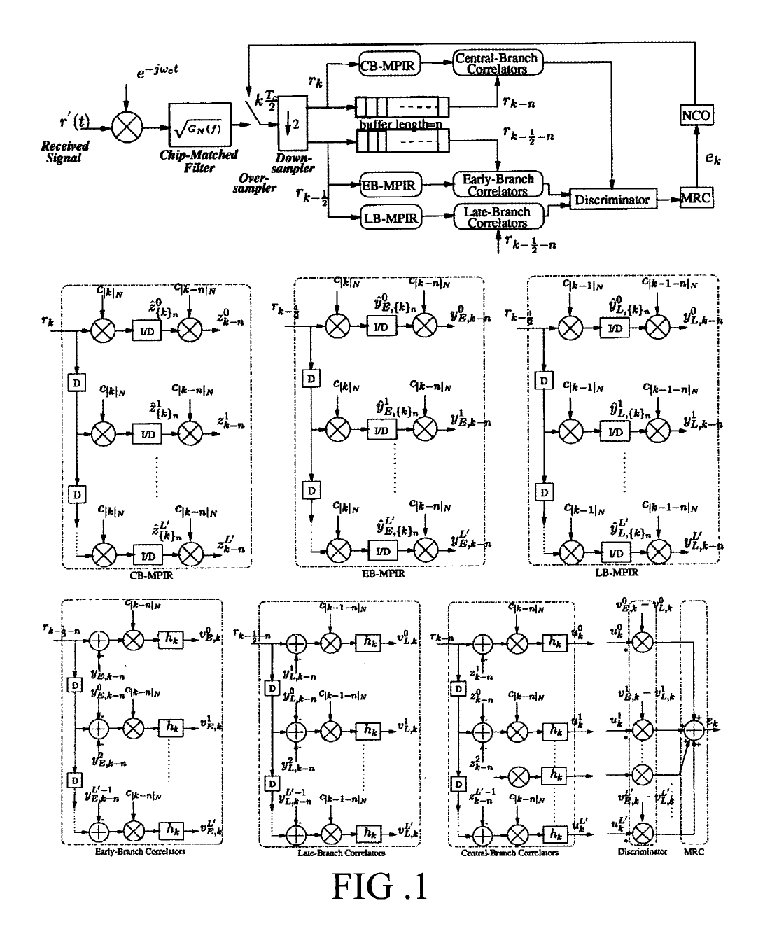

The modulator and demodulator schemes of a bandlimited DS/SS system have been thoroughly studied. To show in detail the operations involved in the modified code tracking loop proposed here, its complete block diagram is sketched in FIG. 1. The complex representation of the base-band signal at the output of the chip-matched filter with the square-root raised-cosine transfer function \sqrt{G_{N}(f)} is

$$r ( t ) = {ⅇ}^{j θ ( t )} {\sum }_{l = 0}^{L} {a}_{l} ( t ) {\sum }_{m = - ∞}^{∞} {d}_{\{ m \} M} {c}_{\vert m \vert N} \cdot g [ t - {mT}_{c} + {lT}_{c} ] + n ( t ) \qquad ( 1 )$$

where {m}_{M} and |m|_{N} are the integer quotient (i.e., the integral part of m/M and m modulus N, respectively; M is the processing gain; N is the PN code length; T_{c} is the chip duration; θ(t) denotes the phase error caused by the front-end non-coherent down-conversion process, where its effect can be absorbed intoαₗ(t); d_{{m}}_{_{M}} is the {)}_{M} information-bearing quaternary phase-shift keying (QPSK) complex symbol; cₖ is the kth chip value of the PN sequence; g(t) is the overall chip shape with Fourier transform G (f)=TcGN(f); and the power spectral density of the noise component n(t) is Sₙ(f)=N₀G_{N}(f)|P

The signal r(t) is sampled at the instants tₖ=(k+εₖ)T_{c} and t_{k-(1/2)}=(k+ε_{k-(1/2)})T_{c} (i.e., a sampling rate of 2/T_{c}), where εₖ is the kth normalized chip timing error, in order to produce two parallel sequences: an integer-instant stream {rₖ=r(tₖ)} and a half-integer-instant stream {τ_{k-(1/2)}=τ(t_{k-(1/2)})}T_{c}

### A. Multipath Interference Regeneration

The integer-instant samples Γₖ are first fed into the central-branch multipath interference regenerator (CB-MPIR), and they are also delayed for the sake of the I/D latency n by means of a buffer before entering the following central-branch correlators; meanwhile, the half-integer-instant samples τ_{k-(1/2)} are sent into both the early branch multipath interference regenerator (EB-MPIR) and the late-branch multipath interference re-generator (LB-MPIR). They are also delayed for the sake of the I/D latency n before entering the early and late-branch correlators. In CB-MPIR, rₖ is first despread by means of C_{|k|}_{_{N}} for each of the L+1 paths, and then the signal propagated through each path can be reproduced by multiplying the output of the I/D filter \hat{Z}^{p}_{{k}}_{ₙ} by the delayed spreading sequence c_{|k-n|}_{_{N}} . Thus, the cross correlation extracted from the integer-instant stream on the finger of the RAKE structure can be expressed as

$${\hat{z}}_{{\{ k \}}_{n}}^{p} = ID \{ {r}_{k - p} \times {c}_{{\vert k \vert}_{N}} \} \qquad ( 2 )$$

where ID {•} denotes the I/D filtering operation

$$( i . e . , ID \{ • \} = ( 1 / n ) {\sum }_{i = 0}^{n - 1} \{ • \} ) .$$

Similar operations are also applied to r_{k-(1/2)} in both EB-MPIR and LB-MPIR. The cross correlation extracted from the half-integer-instant stream on the pth finger of the RAKE receiver can be expressed as

$${\hat{y}}_{E , {\{ k \}}_{n}}^{p} = ID \{ {r}_{k - ( 1 / 2 ) - p} \times {c}_{{\vert k \vert}_{N}} \} \qquad ( 3 )$$

and

$${\hat{y}}_{L , {\{ k \}}_{n}}^{p} = ID \{ {r}_{k - ( 1 / 2 ) - p} \times {c}_{{\vert k - 1 \vert}_{N}} \} \qquad ( 4 )$$

It needs to be noted that the I/D latency n is an important design parameter. It represents the coherent integration duration used by the I/D filtering operation. As a result, it has to be kept shorter than the processing gain M in order to avoid any possibility of data sign inversion effects. In other words, the I/D filters in the EB-, LB-, and CB-MPIR must have bandwidth wide enough to accommodate the data modulation effects. However, the coherent integration duration also has to be long enough to accurately estimate the channel effect, to reject undesired noise, and to effectively regenerate/cancel multipath interference. Since the I/D filtering operation takes n chip durations to perform multipath interference regeneration, the incoming streams of the early-, late-, and central-branch correlators have to be delayed for the sake of I/D latency so that multipath interference cancellation can be performed in the correct phase before cross correlation extraction is performed.

### B. Error Signal and S-Curve of MCTL/MPIC

In the early-, late-, and central-branch correlators, the corresponding MPI from adjacent paths is first subtracted from the delayed integer-instant and the delayed half-integer-instant streams (i.e.,{rₖ₋ₙ} and{r_{k-(1/2)-n}}) before they are cross correlated with the local PN sequence. As a result, the cross correlations on the central-, early-, and late-branch correlators, i.e., uₖ^{p}, v_{E,k}^{p}, and v_{L,k}^{p}, can be expressed as

$$\begin{matrix}{u}_{k}^{p} = \{ [ {r}_{k - p - n} - ( {\hat{z}}_{{\{ k - n \}}_{n}}^{p - 1} + {\hat{z}}_{{\{ k - n \}}_{n}}^{p + 1} ) \times {c}_{{\vert k - n \vert}_{N}} ] \times {c}_{{\vert k - n \vert}_{N}} \} ⊗ {h}_{k} , & \\ {v}_{E , k}^{p} = \{ [ {r}_{k - ( 1 / 2 ) - p - n} - ( {\hat{y}}_{E , {\{ k - n \}}_{n}}^{p - 1} + {\hat{y}}_{E , {\{ k - n \}}_{n}}^{p + 1} ) \times {c}_{{\vert k - n \vert}_{N}} ] \times {c}_{{\vert k - n \vert}_{N}} \} ⊗ {h}_{k} & ( 5 ) \\ and & \\ {v}_{L , k}^{p} = \{ [ {r}_{k - ( 1 / 2 ) - p - n} - ( {\hat{y}}_{L , {\{ k - n \}}_{n}}^{p - 1} + {\hat{y}}_{L , {\{ k - n \}}_{n}}^{p + 1} ) \times {c}_{{\vert k - 1 - n \vert}_{N}} ] \times {c}_{{\vert k - 1 - n \vert}_{N}} \} ⊗ {h}_{k} & \end{matrix}$$

where \mathring{×} denotes the convolution operator; hₖ is the impulse response function of the first-order low-pass filter, the transfer function of which is H(Z)=(1−b)/(1−bZ⁻¹), b=exp(−2πB_{b}T_{c}), which has bandwidth B_{b} comparable with the symbol rate 1/T. The data modulation effect and the channel fading effect on v_{E,k}^{p} and v_{L,k}^{p} need to be compensated for by multiplying them with the complex conjugate of uₖ^{p}. In addition, uₖ^{p} can effectively keep the error characteristic on each RAKE finger within the range [−T_{c},T_{c}] in order to reduce the self-interference effect. Therefore, the resultant error signal of the proposed technique, which is called the modified code tracking loop with multipath interference cancellation (MCTL/MPIC) for simplicity, can be obtained by means of maximum ratio combining (MRC) criterion and expressed as

$${e}_{k}^{MCTL / MPIC} = {R}_{e} \{ {\sum }_{∀ p} {e}_{k}^{p} \} = {R}_{e} \{ {\sum }_{∀ p} {( {u}_{k}^{p} )}^{*} \cdot ( {v}_{E , k}^{p} - {v}_{L , k}^{p} ) \} \qquad ( 6 )$$

where (•)* denotes the operation of taking the complex conjugate.

After some manipulations, which are described in Appendix, the error signal of MCTL/MPIC for εₖ=ε can be rewritten as

eₖ^{MCTL/MPIC}=(5Γ₀−8Γ₁+4Γ₂−Γ₃)·S₁(ε)+(3Γ₀−6Γ₁+5Γ₂−3Γ₃+Γ₄)·S₂(ε)+(5Γ₀−8Γ₁+4Γ₂−Γ₃)·S₃(ε) (7)

where

$$\begin{matrix}{S}_{1} ( ϵ ) = g ( ϵ {T}_{c} ) \{ g [ ( ϵ - \frac{1}{2} ) {T}_{c} ] - g [ ( ϵ + \frac{1}{2} ) {T}_{c} ] \} \\ {S}_{2} ( ϵ ) = g [ ( ϵ - 1 ) {T}_{c} ] g [ ( ϵ + \frac{1}{2} ) {T}_{c} ] - g [ ( ϵ + 1 ) {T}_{c} ] g [ ( ϵ - \frac{1}{2} ) {T}_{c} ] \\ {S}_{3} ( ϵ ) = g [ ( ϵ + 1 ) {T}_{c} ] g [ ( ϵ + \frac{1}{2} ) {T}_{c} ] - g [ ( ϵ - 1 ) {T}_{c} ] g [ ( ϵ - \frac{1}{2} ) {T}_{c} ] \\ {Γ}_{0} = {\sum }_{∀ p} {‖ {a}_{p} ‖}^{2} \\ {Γ}_{1} = {\sum }_{∀ p} Re \{ {a}_{p} {a}_{p + 1}^{*} \} \\ {Γ}_{2} = {\sum }_{∀ p} Re \{ {a}_{p} {a}_{p + 2}^{*} \} \\ {Γ}_{3} = {\sum }_{∀ p} Re \{ {a}_{p} {a}_{p + 3}^{*} \}\end{matrix}$$

and

$${Γ}_{4} = {\sum }_{∀ p} Re \{ {a}_{p} {a}_{p + 4}^{*} \}$$

It needs to be noted that Γ₀, Γ₁, Γ₂, Γ₃, Γ₄ all vary over time with the variation of the channel effects, though no apparent symbol k or t is employed here. If αₗ, ∀l, are independent complex Gaussian random variables with zero means, then the error characteristic (i.e., the so-called S-curve) can be further formulated as

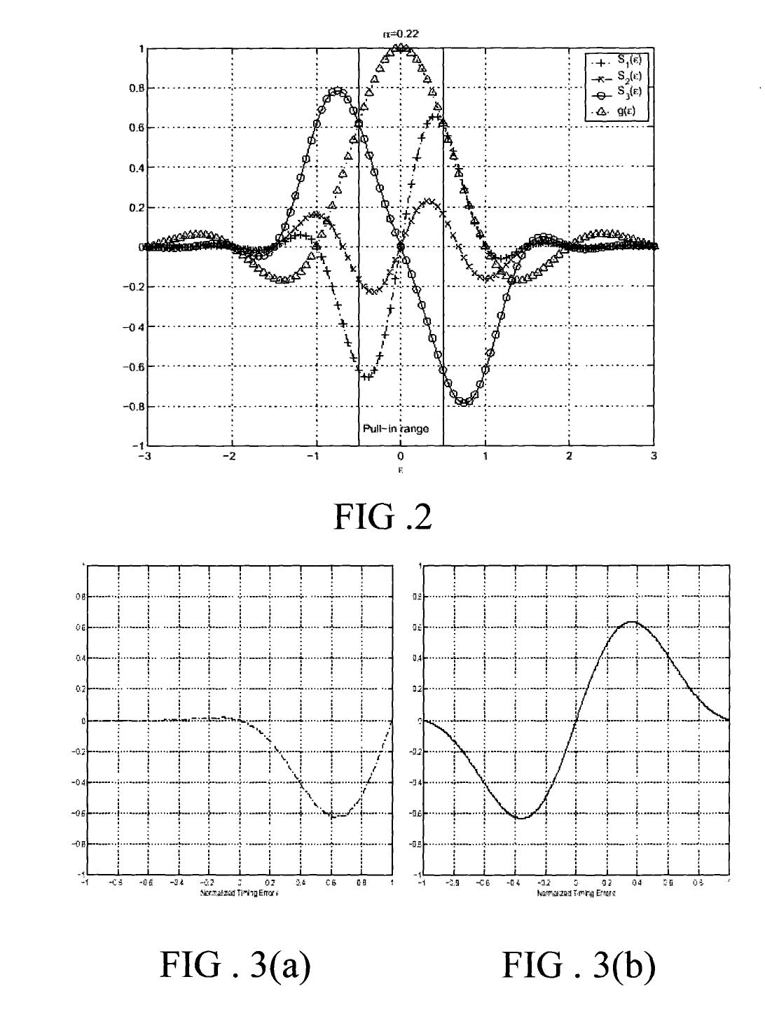

S^{MCTL/MPIC}(ε)=<E{Γ₀{>[5S₁(ε)+3S₂(ε)+5S₃(ε)] (8)

where<•>and E{•}denote the time-average and expectation operations, respectively. No matter what kind of combination of the channel tap weights αₗ, ∀l (say, uncorrelated, correlated, or arbitrarily correlated with time-varying cross correlations among multiple propagation paths), is considered, both the error signal and the S-curve of MCTL/MPIC have been proven to be definitely odd-symmetric with respect to their common locked point at ε=0 because S₁(ε), S₂(ε), and S₃(ε) all have this property. Note that the shapes of S₁(ε), S₂(ε), and S₃(ε) are plotted in FIG. 2.

### C. Error Signal and S-Curve of MCTL

The error signal of a similar structure with no multipath interference cancellation, called MCTL here for simplicity, can be rederived and expressed as

$$\begin{matrix}{e}_{k}^{MCTL} = Re \{ {\sum }_{∀ p} {( {\overline{u}}_{k}^{p} )}^{*} ( {\overline{v}}_{E , k}^{p} - {\overline{v}}_{L , k}^{p} ) \} \\ = ( {Γ}_{0} - {Γ}_{1} ) {S}_{1} ( ϵ ) + ( {Γ}_{2} - {Γ}_{1} ) {S}_{2} ( ϵ ) + ( {Γ}_{0} - {Γ}_{1} ) {S}_{3} ( ϵ )\end{matrix} \qquad ( 9 )$$

where

$$\begin{matrix}{\overline{u}}_{k}^{p} = \{ {r}_{k - p - n} \times {c}_{{\vert k - n \vert}_{N}} \} ⊗ {h}_{k} , \\ {\overline{v}}_{E , k}^{p} = \{ {r}_{k - ( 1 / 2 ) - p - n} \times {c}_{{\vert k - n \vert}_{N}} \} ⊗ {h}_{k} , \\ {\overline{v}}_{L , k}^{p} = \{ {r}_{k - ( 1 / 2 ) - p - n} \times {c}_{{\vert k - 1 - n \vert}_{N}} \} ⊗ {h}_{k}\end{matrix} \qquad ( 10 )$$

If the channel tap weights are zero-mean and independent of one another, then the S-curve of MCTL can be formulated as

S^{MCTL}(ε)=<E{Γ₀}>[S₁(ε)+S₃(ε)]. (11)

Similarly, the error signal and S-curve of MCTL are odd-symmetric with respect to the same locked point at ε=0 under any channel condition.

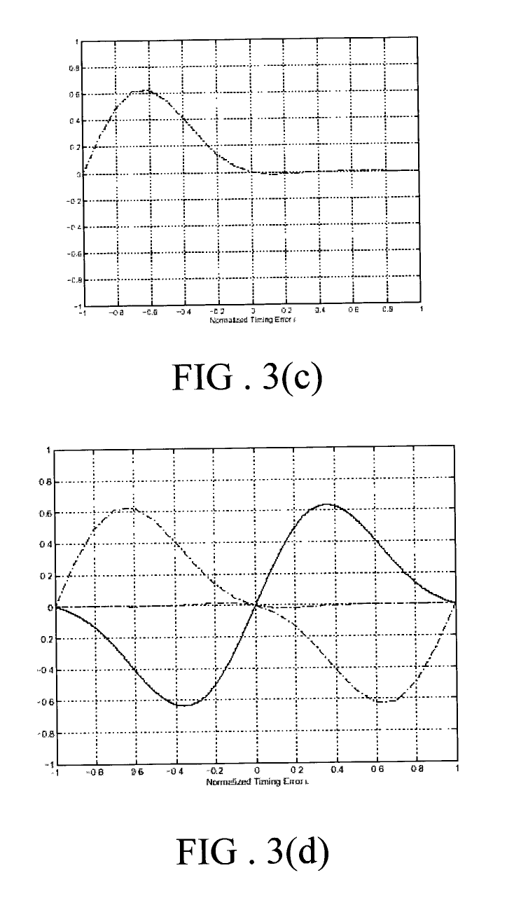

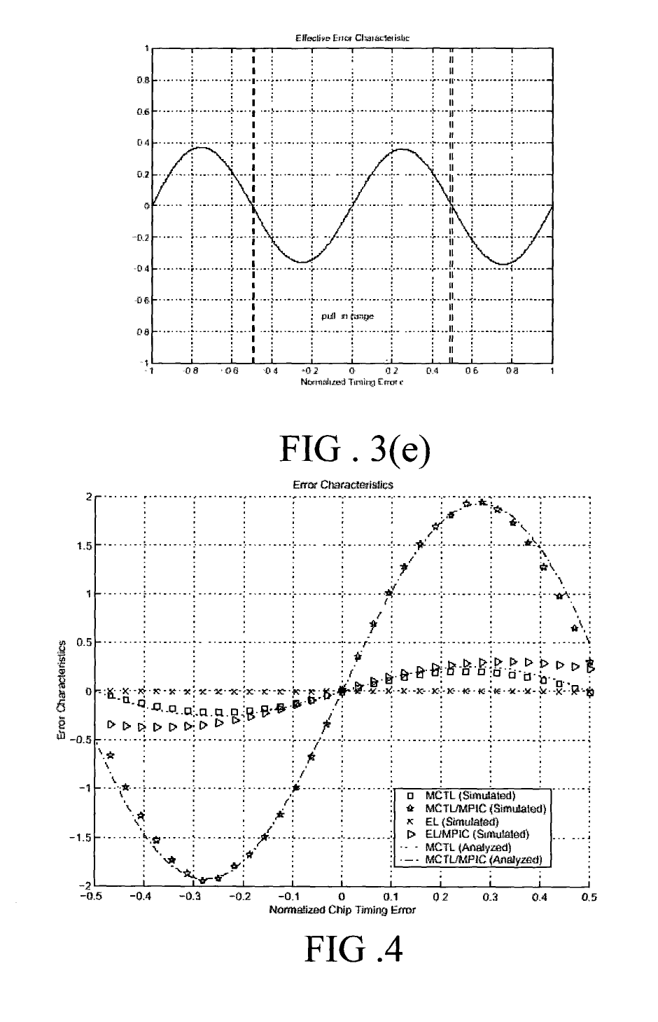

In the case where the channel tap weights are assumed to be zero-mean and independent of one another, the error signal on each finger still suffers from self-interference generated by the adjacent RAKE fingers. For a certain propagation path, some typical finger error signal is detected on the corresponding finger, and its error characteristic can then be depicted as shown in FIG. 3(b). However, the residual cross correlation, which is beyond the half-chip duration, will inevitably be detected and cause some undesired error characteristics (i.e., self-interference), as shown in FIG. 3(a) and (c), on the preceding and succeeding RAKE fingers, respectively. The desired error characteristic and the self-interference are replotted by means of the solid and dashed curves, respectively, in FIG. 3(d). The self-interference naturally blocks the desired error characteristic. The effective error characteristic extracted by MCTL with MRC from an individual propagation path is thus depicted in FIG. 3(e). As a result, the resultant error characteristic of the proposed MCTL with MRC is the superposition of the effective error characteristics extracted by all the RAKE fingers. Meanwhile, any specific RAKE finger can detect a typical error signal from the corresponding propagation path as well as those from the adjacent propagation paths by means of the confinement capability supported by the central-branch correlation. Therefore, only multipath interference from adjacent paths has to be dealt with when the proposed MPIC technique is employed.

### D. Comparison

For the purpose of comparison, we also present the error signals of RAKE-based code tracking loops with early-late (EL) square-law discriminators operating on each finger. Their error signals are

$$\begin{matrix}{e}_{k}^{EL / MPIC} = {\sum }_{∀ p} \{ {‖ {v}_{E , k}^{p} ‖}^{2} - {‖ {v}_{L , k}^{p} ‖}^{2} \} & ( 12 ) \\ {e}_{k}^{EL} = {\sum }_{∀ p} \{ {‖ {v}_{E , k}^{p} ‖}^{2} - {‖ {v}_{L , k}^{p} ‖}^{2} \} & ( 13 )\end{matrix}$$

for loops with and without MPIC, respectively. It can be shown that the multipath interference causes the error signals to be biased by the residual cross correlation from adjacent paths, thus resulting in movement of locked points. This is also explained in more detail in the Appendix.

### 3. Numerical Results

The numerical results obtained through both the above-mentioned statistical analysis and Monte Carlo simulation on a computer are presented in this section. The simulation parameters are given below:

| | |
|---|---|
| modulation | QPSK; |
| carrier frequency | 900 MHz; |
| PN code | m-sequence with generating polynomial |
| | g(x) = 1 + x³ + x⁷ |
| chip shaping | square-root raised cosine with a rolloff factor α= 0.22; |
| chip rate | 1/T_{c} = 1.27 M chips/s; |
| symbol rate | 1/T = 10K symbols/s; |

32 samples per chip duration; channel three propagation paths with equal power, the relative delay between successive multipath components T_{c} where each path is modeled as an independent Jakes fading with a maximal fading rate of 83.3 Hz; thus, each tap weight has Rayleigh distributed magnitude and uniformly distributed phase; five fingers employed here to avoid any possibility of energy loss, with branch filter bandwidth B_{b}=1/T; normalized bandwidth B_{L}T_{c}=10⁻³, 5×10⁻³, 10⁻⁴and 5×10⁻⁴; n=16, 32, and 64; 50 000 QPSK data symbols.

FIG. 4 shows the S-curves of the compared code tracking loops. The dotted and dashed curves denote the theoretical S-curves of MCTL and MCTL/MPIC, respectively, while the simulation results of MCTL, MCTL/MPIC, EL, and EL/MPIC are also plotted. It is obvious that the simulation results are very close to those obtained in the previous statistical analysis. Furthermore, MCTL/MPIC exhibits a much more robust pull-in capability than the others, and MCTL still has a higher S-curve than either EL or EL/MPIC. The S-curve of EL is insignificant because EL and EL/MPIC actually suffer from non-negligible multipath interference. It is obvious from FIG. 4 that the S-curve bias problem caused by frequency-selective fading has been mitigated using the proposed techniques.

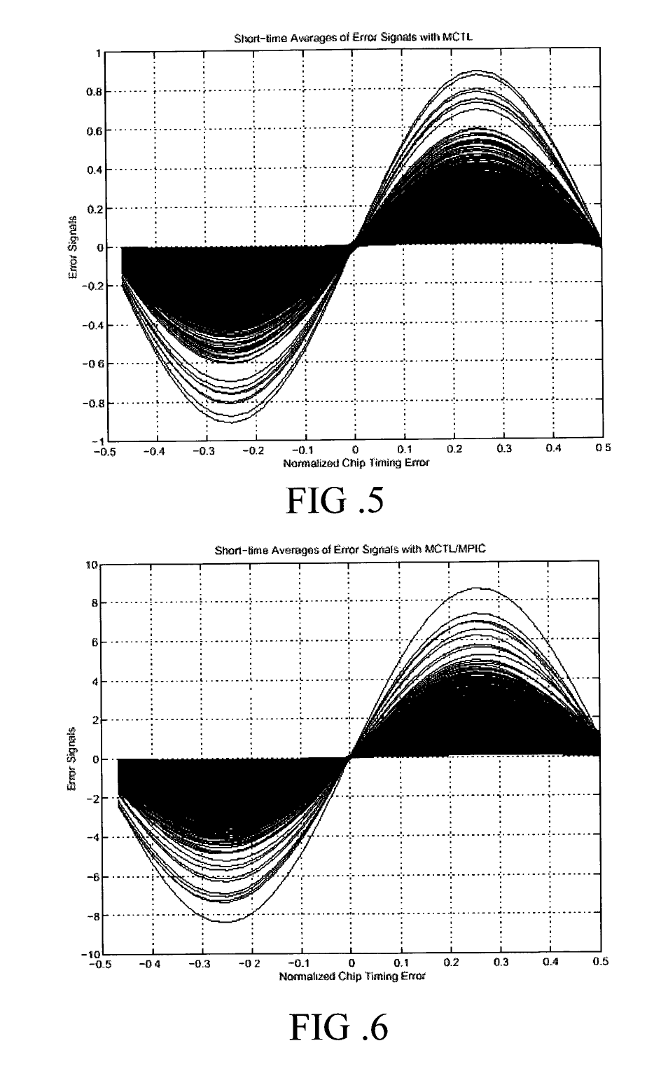

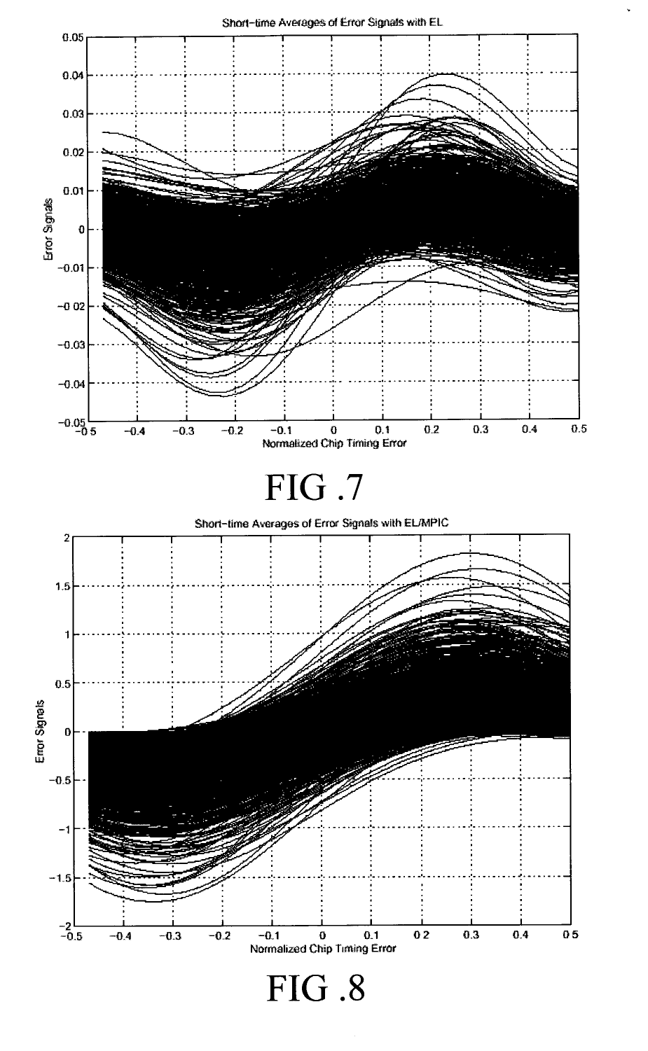

To further verify the pull-in capabilities of the compared techniques on a time-variant multipath channel, many short-time averages of the error signals with MCTL, MCTL/MPIC, EL, and EL/MPIC were simulated and are plotted in FIGS. 5-8, respectively. It can be easily seen that MCTLand MCTL/MPIC always have odd-symmetric error signals and a static locked point at ε=0, thus validating their pull-in capabilities. However, the locked points of the error signals of EL and EL/MPIC change due to time-varying channel effects because multipath interference may be introduced from the adjacent paths in the discriminators. In MCTL and MCTL/MPIC, the central-branch correlators can effectively limit the residual cross correlation resulting from the early and late correlations; thus, much more stable error signals can be achieved, as shown in FIGS. 5 and 6.

Because the signal received from each path is detected individually, in the conventional delay-locked loop (DLL), the superposition of these individual error signals introduces self-interference, which in turn causes divergence or movement of the resultant error signals within several chip durations. The employed channel is the worst case because in this case, each path drags the locked point from one to another locked point with equal probability. From the above, it can be seen that multipath introduces significant timing errors and that simulation of the tracking jitter and MTLL for the conventional DLL and the techniques proposed previously on theoretical multipath channels is not necessary because they have been proven to be vulnerable to multipath channel effects. To evaluate the steady-state performance of the proposed technique, the normalized loop bandwidth has to be defined here as

$${B}_{L} {T}_{c} = \frac{γ A}{2 ( 2 - γ A )} \qquad ( 14 )$$

where γ denotes the numerically controlled oscillator sensitivity and is the slope at of the loop error characteristics, which can be written as

$$A = ⟨ E \{ {Γ}_{0} \} ⟩ \cdot [ \frac{5 π α sin ( \frac{π α}{2} ) ( 1 - {α}^{2} ) + 2 cos ( \frac{π α}{2} ) ( 1 - 3 {α}^{2} )}{\frac{π}{4} {( 1 - {α}^{2} )}^{2}} - \frac{4 cos ( π α ) cos ( \frac{π α}{2} )}{\frac{π}{2} ( 1 - {α}^{2} ) ( 1 - 4 {α}^{2} )} ]$$

for MCTL/MPIC, and

$$A = ⟨ E \{ {Γ}_{0} \} ⟩ \cdot [ \frac{π α sin ( \frac{π α}{2} ) ( 1 - {α}^{2} ) + 2 cos ( \frac{π α}{2} ) ( 1 - 3 {α}^{2} )}{\frac{π}{4} {( 1 - {α}^{2} )}^{2}} - \frac{2 cos ( π α ) cos ( \frac{π α}{2} )}{\frac{π}{2} ( 1 - {α}^{2} ) ( 1 - 4 {α}^{2} )} ]$$

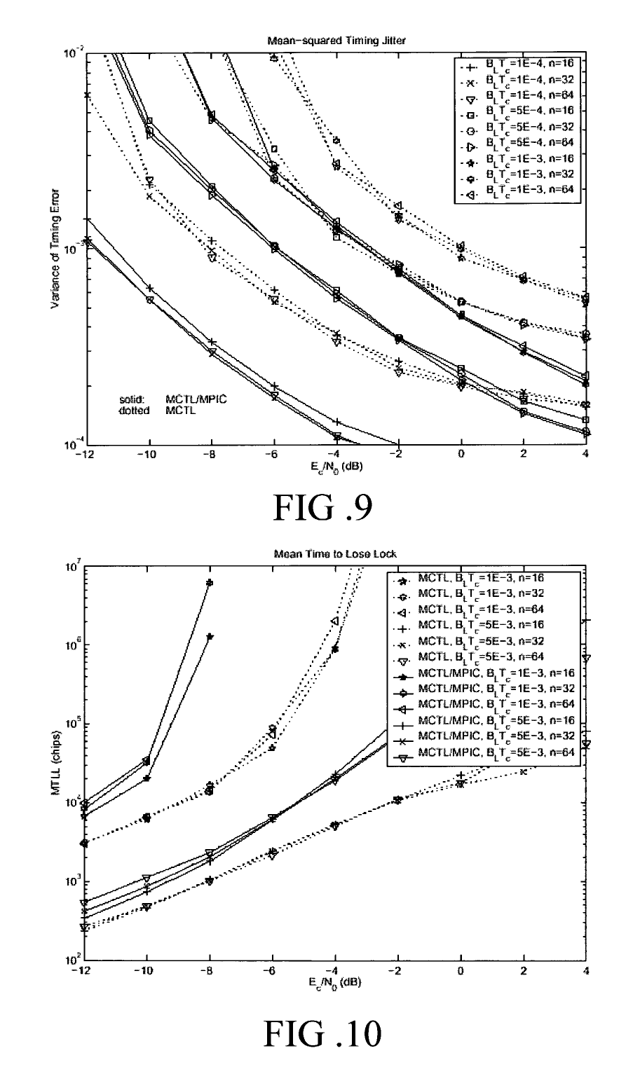

for MCTL. The mean squared timing errors for MCTL/MPIC and MCTL with various values of the normalized loop bandwidth B_{L}T_{c} under different signal-to-noise ratio (SNR) conditions were obtained through computer simulations and are shown in FIG. 9. It can be seen from this figure that the mean squared timing errors for MCTL/MPIC are much lower than those for MCTL. This indicates that MCTL/PIC provides more stable steady-state performance in terms of timing jitter under the same normalized loop bandwidth B_{L}T_{c}.

MTLL is very important for a code tracking loop, especially under the low SNR conditions. For a conventional DLL, MTLL denotes the average time that a tracking loop remains synchronized. Similarly, MTLL for the proposed modified code tracking loop is defined as the mean time that all fingers of the RAKE structure remain synchronized. In other words, MTLL is also the mean time between two consecutive instants at which one of the fingers loses lock. The simulated results for MTLL of the proposed modified code tracking loops with or without MPIC under different SNR conditions are presented in FIG. 10. We can see that MCTL/MPIC always has longer MTLL than MCTL does. This makes sense because the larger area under the S-curve of MCTL/MPIC for positive ε implies the existence of a higher level of escape energy needed to leave a lock state, which can support longer MTLL.

### 4. Conclusion

In this invention, a novel modified code tracking loop has been proposed for direct-sequence spread-spectrum communication over a frequency-selective fading channel. By taking advantage of the inherent diversity and multipath interference cancellation schemes, the proposed technique can provide better pull-in capability. Analytical results of S-curves have been derived and then confirmed by means of computer simulation. In addition, extensive computer simulation results for error signals, timing jitter, and MTLL have been provided for the purpose of comparison. Very encouraging improvements can undoubtedly be achieved and have been clearly proven.

### Appendix

### Derivation of Error Signal

To derive the error signal and S-curve of the proposed technique in more detail, many equations are taken into consideration in the following. The cross correlation extracted from the integer-instant stream on the pth finger of the RAKE structure shown in (2) can be rewritten as

$$\begin{matrix}{}_{}^{{z}^{\hat{} p}}{\{ k \}}{}_{n}^{} = ID \{ {r}_{k - p} \times {c}_{\vert k \vert N} \} \\ = {a}_{p} {d}_{{\{ k \}}_{M}} g [ {ϵ}_{k} {T}_{c} ] + {a}_{p + 1} {d}_{{\{ k \}}_{M}} g [ ( {ϵ}_{k} + 1 ) {T}_{c} ] + \\ {a}_{p - 1} {d}_{{\{ k \}}_{M}} g [ ( {ϵ}_{k} + 1 ) {T}_{c} ] + {\hat{n}}_{k}^{p} + {\hat{δ}}_{M , k}^{p}\end{matrix} \qquad ( 17 )$$

where

\hat{n}ₖ^{p}=ID{nₖ₋ₚ×c_{|k|N}}

and

$${\hat{δ}}_{M , k}^{p} = ID \{ {\sum }_{l = 0}^{L} {a}_{l} {\sum }_{m \neq k} {d}_{\{ m \} M} {c}_{{\vert k \vert}_{N}} {c}_{{\vert m \vert}_{N}} \cdot g [ ( k - m - p + l + {ϵ}_{k} ) {T}_{c} ] \}$$

is the negligible residual cross correlation. Here, we have dropped out the argument t from αₗ(t) for the sake of simplicity because the variation of a channel is usually slow enough to be treated as constant within several chip durations.

Similarly, ŷ_{E,{k}}_{ₙ}^{p} and ŷ_{L,{k}}_{ₙ}^{p} can be rewritten in more detail as

$$\begin{matrix}{\hat{y}}_{E , {\{ k \}}_{N}}^{p} = ID \{ {r}_{k - ( 1 / 2 ) - p} \times {c}_{\vert k \vert N} \} \\ = {a}_{p} {d}_{\{ k \} M} g [ ( {ϵ}_{k} - \frac{1}{2} ) {T}_{c} ] + \\ {a}_{p + 1} {d}_{{\{ k - 1 \}}_{M}} g [ ( {ϵ}_{k} + \frac{1}{2} ) {T}_{c} ] + {\hat{n}}_{E , k}^{p} + {\hat{δ}}_{E , k}^{p}\end{matrix} \qquad ( 18 )$$

and

$$\begin{matrix}{\hat{y}}_{L , {\{ k \}}_{N}}^{p} = ID \{ {r}_{k - ( 1 / 2 ) - p} \times {c}_{\vert k - 1 \vert N} \} \\ = {a}_{p} {d}_{\{ k - 1 \} M} g [ ( {ϵ}_{k} + \frac{1}{2} ) {T}_{c} ] + \\ {a}_{p - 1} {d}_{{\{ k - 1 \}}_{M}} g [ ( {ϵ}_{k} - \frac{1}{2} ) {T}_{c} ] + {\hat{n}}_{L , k}^{p} + {\hat{δ}}_{L , k}^{p}\end{matrix} \qquad ( 19 )$$

where

$$\begin{matrix}{\hat{δ}}_{E , k}^{p} = ID \{ {\sum }_{l \neq p , p + 1} {a}_{l} {d}_{{\{ k \}}_{M}} g [ ( {ϵ}_{k} + l - p - \frac{1}{2} ) {T}_{c} ] + \\ {\sum }_{l = 0}^{L} {a}_{l} {\sum }_{m \neq k} {d}_{{\{ m \}}_{M}} {c}_{\vert m \vert N} {c}_{\vert k \vert N} \cdot g [ ( k - m + l - p + {ϵ}_{k} - \frac{1}{2} ) {T}_{c} ] \}\end{matrix}$$

$$\begin{matrix}{\hat{δ}}_{L , k}^{p} = ID \{ {\sum }_{l \neq p , p + 1} {a}_{l} {d}_{{\{ k - 1 \}}_{M}} g [ ( {ϵ}_{k} + l - p + \frac{1}{2} ) {T}_{c} ] + \\ {\sum }_{l = 0}^{L} {a}_{l} {\sum }_{m \neq k - 1} {d}_{{\{ m \}}_{M}} {c}_{\vert m \vert N} {c}_{\vert k - 1 \vert N} \cdot g [ ( k - m + l - p + {ϵ}_{k} - \frac{1}{2} ) {T}_{c} ] \}\end{matrix}$$

Furthermore, the cross correlation on the pth central, early, and late branch, i.e., uₖ^{p}, v_{E,k}^{p}, and v_{L,k}^{p}, can be rewritten in more detail as

$$\begin{matrix}\begin{matrix}{u}_{k}^{p} = \{ [ {r}_{k - p - n} - ( {\hat{z}}_{{\{ k - n \}}_{n}}^{p - 1} + {\hat{z}}_{{\{ k - n \}}_{n}}^{p + 1} ) \times {c}_{{\vert k - n \vert}_{N }} ] \times {c}_{{\vert k - n \vert}_{N}} \} ⊗ {h}_{k} \\ = {\tilde{z}}_{{\{ k - n \}}_{n}}^{p} - ( {\hat{z}}_{{\{ k - n \}}_{n}}^{p - 1} + {\hat{z}}_{{\{ k - n \}}_{n}}^{p + 1} ) ⊗ {h}_{k} \\ = ( {a}_{p} - {a}_{p - 1} - {a}_{p + 1} ) {d}_{{\{ k - n \}}_{M}} g [ {ϵ}_{k - n} {T}_{c} ] + \\ ( {a}_{p + 1} - {a}_{p} - {a}_{p + 2} ) {d}_{{\{ k - n \}}_{M}} g \{ ( {ϵ}_{k - n} + 1 ) {T}_{c} ] + \\ ( {a}_{p - 1} - {a}_{p - 2} - {a}_{p} ) {d}_{{\{ k - n \}}_{M}} g \{ ( {ϵ}_{k - n} - 1 ) {T}_{c} ] + \\ {\tilde{n}}_{k}^{p} - {\tilde{\hat{n}}}_{k}^{p - 1} - {\tilde{\hat{n}}}_{k}^{p + 1} + {\tilde{δ}}_{M , k}^{p} - {\tilde{\hat{δ}}}_{M , k}^{p - 1} - {\tilde{\hat{δ}}}_{M , k}^{p + 1} ,\end{matrix} \\ \begin{matrix}{u}_{E , k}^{p} = \{ [ {r}_{k - ( 1 / 2 ) - p - n} - ( {\hat{y}}_{E , {\{ k - n \}}_{n}}^{p - 1} + {\hat{y}}_{E , {\{ k - n \}}_{n}}^{p + 1} ) \times {c}_{{\vert k - n \vert}_{N }} ] \times {c}_{{\vert k - n \vert}_{N}} \} ⊗ {h}_{k} \\ = ( {a}_{p} - {a}_{p + 1} - {a}_{p - 1} ) {d}_{{\{ k - n \}}_{M}} g \{ ( {ϵ}_{k - n} - \frac{1}{2} ) {T}_{c} ] + \\ ( {a}_{p + 1} - {a}_{p + 2} - {a}_{p} ) {d}_{{\{ k - n \}}_{M}} g \{ ( {ϵ}_{k - n} + \frac{1}{2} ) {T}_{c} ] + \\ {\tilde{n}}_{E , k}^{p} - {\tilde{\hat{n}}}_{E , k}^{p - 1} - {\tilde{\hat{n}}}_{E , k}^{p + 1} + {\tilde{δ}}_{E , k}^{p} - {\tilde{\hat{δ}}}_{E , k}^{p - 1} - {\tilde{\hat{δ}}}_{E , k}^{p + 1}\end{matrix} \\ \begin{matrix}{u}_{L , k}^{p} = \{ [ {r}_{k - ( 1 / 2 ) - p - n} - ( {\hat{y}}_{L , {\{ k - n \}}_{n}}^{p - 1} + {\hat{y}}_{L , {\{ k - n \}}_{n}}^{p + 1} ) \times {c}_{{\vert k - 1 - n \vert}_{N }} ] \times {c}_{{\vert k - 1 - n \vert}_{N}} \} ⊗ {h}_{k} \\ = ( {a}_{p} - {a}_{p + 1} - {a}_{p - 1} ) {d}_{{\{ k - 1 - n \}}_{N}} g \{ ( {ϵ}_{k - n} + \frac{1}{2} ) {T}_{c} ] + \\ ( {a}_{p - 1} - {a}_{p} - {a}_{p - 2} ) {d}_{{\{ k - 1 - n \}}_{M}} g \{ ( {ϵ}_{k - n} + \frac{1}{2} ) {T}_{c} ] + \\ {\tilde{n}}_{L , k}^{p} - {\tilde{\hat{n}}}_{L , k}^{p - 1} - {\tilde{\hat{n}}}_{L , k}^{p + 1} + {\tilde{δ}}_{L , k}^{p} - {\tilde{\hat{δ}}}_{L , k}^{p - 1} - {\tilde{\hat{δ}}}_{L , k}^{p + 1}\end{matrix}\end{matrix}$$

where

$$\begin{matrix}{\tilde{n}}_{K}^{P} = ( {n}_{k - n - p} \times {c}_{{\vert k - n \vert}_{N}} ) ⊗ {h}_{k} \\ {\tilde{\hat{n}}}_{K}^{P - 1} = {\hat{n}}_{k - n}^{p - 1} ⊗ {h}_{k} ⟨ ⟨ {\tilde{n}}_{k}^{p} \\ {\tilde{\hat{n}}}_{K}^{P + 1} = {\hat{n}}_{k - n}^{p + 1} ⊗ {h}_{k} ⟨ ⟨ {\tilde{n}}_{k}^{p} \\ {\tilde{n}}_{E , K}^{P} = ( {n}_{k - ( 1 / 2 ) - n - p} \times {c}_{{\vert k - n \vert}_{N}} ) ⊗ {h}_{k} \\ {\tilde{\hat{n}}}_{E , K}^{P - 1} = {\hat{n}}_{E , k - n}^{p - 1} ⊗ {h}_{k} ⟨ ⟨ {\tilde{n}}_{E , k}^{p} \\ {\tilde{\hat{n}}}_{E , K}^{P + 1} = {\hat{n}}_{E , k - n}^{p + 1} ⊗ {h}_{k} ⟨ ⟨ {\tilde{n}}_{E , k}^{p} \\ {\tilde{n}}_{L , K}^{P} = ( {n}_{k - ( 1 / 2 ) - n - p} \times {c}_{{\vert k - 1 - n \vert}_{N}} ) ⊗ {h}_{k} \\ {\tilde{\hat{n}}}_{L , K}^{P - 1} = {\hat{n}}_{E , k - n}^{p - 1} ⊗ {h}_{k} ⟨ ⟨ {\tilde{n}}_{L , k}^{p} \\ {\tilde{\hat{n}}}_{L , K}^{P + 1} = {\hat{n}}_{E , k - n}^{p + 1} ⊗ {h}_{k} ⟨ ⟨ {\tilde{n}}_{L , k}^{p} \\ {\tilde{δ}}_{M , k}^{p} = ( {\sum }_{l = 0}^{L} {a}_{l} {\sum }_{m \neq k} {d}_{{\{ m \}}_{M}} {c}_{{\vert k \vert}_{N}} {c}_{{\vert m \vert}_{N}} \times g [ ( k - m - p + l + {ϵ}_{k} ) {T}_{c} ] ) ⊗ {h}_{k} \\ {\tilde{δ}}_{E , k}^{p} = ( {\sum }_{l = 0}^{L} {a}_{l} {\sum }_{m \neq k} {d}_{{\{ m \}}_{M}} {c}_{{\vert k \vert}_{N}} {c}_{{\vert m \vert}_{N}} \times g [ ( k - m - p + l + {ϵ}_{k} - \frac{1}{2} ) {T}_{c} ] ) ⊗ {h}_{k} \\ {\tilde{δ}}_{L , k}^{p} = ( {\sum }_{l = 0}^{L} {a}_{l} {\sum }_{m \neq k - 1} {d}_{{\{ m \}}_{M}} {c}_{{\vert k - 1 \vert}_{N}} {c}_{{\vert m \vert}_{N}} \times g [ ( k - m - p + l + {ϵ}_{k} - \frac{1}{2} ) {T}_{c} ] ) ⊗ {h}_{k} \\ {\tilde{\hat{δ}}}_{M , k}^{P - 1} = {\hat{δ}}_{M , k - n}^{p - 1} ⊗ {h}_{k} ⟨ ⟨ {\tilde{δ}}_{M , k}^{p} \\ {\tilde{\hat{δ}}}_{M , k}^{P + 1} = {\hat{δ}}_{M , k - n}^{p + 1} ⊗ {h}_{k} ⟨ ⟨ {\tilde{δ}}_{M , k}^{p} \\ {\tilde{\hat{δ}}}_{E , k}^{P - 1} = {\hat{δ}}_{E , k - n}^{p - 1} ⊗ {h}_{k} ⟨ ⟨ {\tilde{δ}}_{E , k}^{p} \\ {\tilde{\hat{δ}}}_{E , k}^{P + 1} = {\hat{δ}}_{E , k - n}^{p + 1} ⊗ {h}_{k} ⟨ ⟨ {\tilde{δ}}_{E , k}^{p} \\ {\tilde{\hat{δ}}}_{L , k}^{P - 1} = {\hat{δ}}_{L , k - n}^{p - 1} ⊗ {h}_{k} ⟨ ⟨ {\tilde{δ}}_{L , k}^{p} \\ {\tilde{\hat{δ}}}_{L , k}^{P + 1} = {\hat{δ}}_{L , k - n}^{p + 1} ⊗ {h}_{k} ⟨ ⟨ {\tilde{δ}}_{L , k}^{p}\end{matrix}$$

Furthermore, let us rewrite the definitions of Γ₀, Γ₁, Γ₂, Γ₃ and Γ₄ as

$${Γ}_{0} = {\sum }_{∀ p} {‖ {a}_{p} ‖}^{2} = {\sum }_{∀ p} {‖ {a}_{p + 1} ‖}^{2} = {\sum }_{∀ p} {‖ {a}_{p - 1} ‖}^{2} , \\ {Γ}_{1} = {\sum }_{∀ p} Re \{ {a}_{p} {a}_{p + 1}^{*} \} = {\sum }_{∀ p} Re \{ {a}_{p}^{*} {a}_{p + 1} \} = {\sum }_{∀ p} Re \{ {a}_{p} {a}_{p - 1}^{*} \} = {\sum }_{∀ p} Re \{ {a}_{p}^{*} {a}_{p - 1} \} = {\sum }_{∀ p} Re \{ {a}_{p - 1} {a}_{p - 2}^{*} \} = {\sum }_{∀ p} Re \{ {a}_{p - 1}^{*} {a}_{p - 2} \} = {\sum }_{∀ p} Re \{ {a}_{p + 1} {a}_{p + 2}^{*} \} = {\sum }_{∀ p} Re \{ {a}_{p + 1}^{*} {a}_{p + 2} \} \\ {Γ}_{2} = {\sum }_{∀ p} Re \{ {a}_{p} {a}_{p + 2}^{*} \} = {\sum }_{∀ p} Re \{ {a}_{p}^{*} {a}_{p + 2} \} = {\sum }_{∀ p} Re \{ {a}_{p} {a}_{p - 2}^{*} \} = {\sum }_{∀ p} Re \{ {a}_{p}^{*} {a}_{p - 2} \} = {\sum }_{∀ p} Re \{ {a}_{p} - 1 {a}_{p + 1}^{*} \} = {\sum }_{∀ p} Re \{ {a}_{p - 1}^{*} {a}_{p + 1} \} , \\ {Γ}_{3} = {\sum }_{∀ p} Re \{ {a}_{p} {a}_{p + 3}^{*} \} = {\sum }_{∀ p} Re \{ {a}_{p}^{*} {a}_{p + 3} \} = {\sum }_{∀ p} Re \{ {a}_{p - 1} {a}_{p + 2}^{*} \} = {\sum }_{∀ p} Re \{ {a}_{p - 1}^{*} {a}_{p + 2} \} = {\sum }_{∀ p} Re \{ {a}_{p + 1} {a}_{p - 2}^{*} \} = {\sum }_{∀ p} Re \{ {a}_{p + 1}^{*} {a}_{p - 2} \} \\ and \\ {Γ}_{4} = {\sum }_{∀ p} Re \{ {a}_{p - 2} {a}_{p + 2}^{*} \} = {\sum }_{∀ p} Re \{ {a}_{p - 2}^{*} {a}_{p + 2} \} \qquad ( 21 )$$

Here, we can force the noise variance to zero in order to focus the derivation on the correlations (and cross correlations) between the signals, which result in the error characteristic and actually contribute to the pull-in capability of the code tracking loop. In fact, the effects caused by AWGN and self-noise will disappear after taking expectation and time-average operations when the error characteristic is only considered in accordance with the independence among the desired, the self-noise, and the noise terms. Based on the above, the error signal of MCTL/MPIC for εₖ=ε can be formulated as shown in (7) by means of some algebraic operations.

In addition, for MCTL, \overline{u}ₖ^{p}, \overline{v}_{E,k}^{p}, \overline{v}_{L,k}^{p} and can be rewritten as

$${\overline{u}}_{k}^{p} = \{ {r}_{k - p - n} \times {c}_{{\vert k - n \vert}_{N}} \} ⊗ {h}_{k} = {a}_{p} {d}_{{\{ k - n \}}_{M}} g [ {ϵ}_{k - n} {T}_{c} ] + {a}_{p + 1} {d}_{{\{ k - n \}}_{M}} g [ ( {ϵ}_{k - n} + 1 ) {T}_{c} ] + {a}_{p - 1} {d}_{{\{ k - n \}}_{M}} g [ ( {ϵ}_{k - n} - 1 ) {T}_{c} ] + {\tilde{n}}_{k}^{p} + {\tilde{δ}}_{M , k}^{p} , \\ {\overline{v}}_{E , k}^{p} = \{ {r}_{k - ( 1 / 2 ) - p - n} \times {c}_{{\vert k - n \vert}_{N}} \} ⊗ {h}_{k} = {a}_{p} {d}_{{\{ k - n \}}_{M}} g [ ( {ϵ}_{k - n} - \frac{1}{2} ) {T}_{c} ] + {a}_{p} {d}_{{\{ k - n \}}_{M}} g [ ( {ϵ}_{k - n} - \frac{1}{2} ) {T}_{c} ] + {\tilde{n}}_{E , k}^{p} + {\tilde{δ}}_{E , k}^{p} \\ {\overline{v}}_{L , k}^{p} = \{ {r}_{k - ( 1 / 2 ) - p - n} \times {c}_{{\vert k - 1 - n \vert}_{N}} \} ⊗ {h}_{k} = {a}_{p} {d}_{{\{ k - 1 - n \}}_{M}} g [ ( {ϵ}_{k - n} + \frac{1}{2} ) {T}_{c} ] + {a}_{p - 1} {d}_{{\{ k - 1 - n \}}_{M}} g [ ( {ϵ}_{k - n} - \frac{1}{2} ) {T}_{c} ] + {\tilde{n}}_{L , k}^{p} + {\tilde{δ}}_{L , k}^{p} \qquad ( 22 )$$

The second terms of \overline{v}_{E,k}^{p}, \overline{v}_{L,k}^{p}, v_{E,k}^{p}, and v_{L,k}^{p} in (20) and (22) inevitably cause self-interference, thus resulting in time- variant movement of locked points of error signals in both EL and EL/MPIC.

What is claimed is:

1. A modified PN code tracking loop for direct-sequence spread-spectrum communication over arbitrarily correlated multipath fading channels providing a fully digital, non-coherent, modified code tracking loop, being able to operate on bandlimited DS/SS systems over frequency-selective fading channels, said modified code tracking loop, assisted by central-branch correlation, embedded into a RAKE receiver in a proposed technique, by taking advantage of central-branch correlation, an error characteristic obtained on each RAKE finger being able to be kept within one chip duration; thus, a kind of self-interference encountered in previous works being able to be effectively reduced, by exploiting inherent diversity using maximum ratio combining (MRC) and multipath interference cancellation (MPIC), said proposed technique being able to avoid unsteadiness in locked points of error signals and, thus, providing an improved error characteristic, it being proven that said error signals obtained using said proposed technique are definitely odd-symmetric with respect to a common locked point over arbitrarily correlated multipath fading channels; furthermore, very attractive improvements obtained using said proposed technique in terms of timing jitter and mean time to lose lock (MTLL) being verified here.

2. The modified PN code tracking loop for direct-sequence spread-spectrum communication over arbitrarily correlated multipath fading channels of claim 1, wherein for a wide-band signal transmitted through a frequency-selective fading channel, signature duration is, in general, much shorter than coherence time of said channel, thus, said channel varies slowly, and its characteristics can be measured accurately, bandwidth of each signature waveform is therefore much wider than coherence bandwidth of said channel, and said frequency-selective fading channel is very often represented as a TDL with tap spacing 1/B_{w} and tap weight coefficients given as zero-mean complex-valued stationary Gaussian random processes, a number of resolvable paths for each user is usually estimated as └B_{w}Tₘ┘+1, where Tₘ is channel multipath spread and └x┘ is a largest integer that is less than or equal to x, with this model, an equivalent low-pass time-varying impulse response of a wide-sense stationary channel with uncorrelated scattering can be represented as
$${h}_{c} ( τ , t ) = {\sum }_{i = 0}^{L} {a}_{l} ( t ) δ ( τ + {lT}_{c} )$$
where h_{c}(τ,t) denotes an impulse response at delay τ and at time instant t, αₗ(t), represents time-varying complex-valued tap weights with Rayleigh distributed magnitudes and uniformly distributed phases, and a number of resolvable paths is (L+1).

3. The modified PN code tracking loop for direct-sequence spread-spectrum communication over arbitrarily correlated multipath fading channels of claim 1, wherein said bandlimited DS/SS system whose complex representation of said base-band signal at an output of a chip-matched filter with a square-root raised-cosine transfer function \sqrt{G_{N}(f)} is
$$r ( t ) = {ⅇ}^{j θ ( t )} {\sum }_{l = 0}^{L} {a}_{l} ( t ) {\sum }_{m = - ∞}^{∞} {d}_{\{ m \} M} {c}_{\vert m \vert N} \cdot g [ t - {mT}_{c} + {lT}_{c} ] + n ( t ) \qquad ( 1 )$$
where {m}_{M} and |m|_{N} are an integer quotient (i.e., an integral part of m/M) and m modulus N, respectively; M is a processing gain; N is a PN code length; T_{c} is a chip duration; θ(t) denotes a phase error caused by a front-end non-coherent down-conversion process, where its effect can be absorbed into αₗ(t) d_{{m}M}; is a {m}_{M} information-bearing quaternary phase-shift keying (QPSK) complex symbol; cₖ is a kth chip value of a PN sequence; g(t) is an overall chip shape with Fourier transformG (f)=T_{c}G_{N}(f); and power spectral density of a noise component n(t) is S_{N}(f)=N₀G_{N} (f)/P, a signal r(t) is sampled at instants tₖ=(k+εₖ)Tₑ and t_{k-(1/2)}=(k+ε_{k-(1/2)})T_{c} (i.e., a sampling rate of 2/T_{c}), where εₖ is a kth normalized chip timing error, in order to produce two parallel sequences: an integer-instant stream {rₖ=r(tₖ)} and a half-integer-instant stream.
{r_{k-(1/2)}=r(t_{k-(1/2)})}

4. The modified PN code tracking loop for direct-sequence spread-spectrum communication over arbitrarily correlated multipath fading channels of claim 1, wherein said multi-path interference regenerator whose integer-instant samples rₖ is first sent to a central-branch multi-path interference regenerator (CB-MPIR) and then, before sending to a central-branch correlator, a buffer for delaying output is needed because of latency of an I/D filter, meanwhile, half-integer-instant samples r_{k-(1/2)} are sent into both an early branch multipath interference regenerator (EB-MPIR) and a late-branch multipath interference regenerator (LB-MPIR), both are also delayed for a sake of I/D latency n before entering early and late-branch correlators. In CB-MPIR, rₖ is first dispread by means of c_{|k|N} for each of L+1 paths, and then said signal propagated through each path can be reproduced by multiplying output of an I/D filter \hat{z}_{{k}}_{ₙ}^{p} by a delayed spreading sequence c_{|k-n|}_{_{N}}, thus, cross correlation extracted from an integer-instant stream on a finger of a RAKE structure can be expressed as
$${\hat{z}}_{{\{ k \}}_{n}}^{p} = ID \{ {r}_{k - p} \times {c}_{{\vert k \vert}_{N}} \}$$
where ID {•}denotes I/D filtering operation
$$( i . e . , ID \{ • \} = ( 1 / n ) {\sum }_{i = 0}^{n - 1} \{ • \} ) ,$$
similar operations are also applied to r_{k-(1/2)} in both EB-MPIR and └B-MPIR, said cross correlation extracted from said half-integer-instant stream on said pth finger of said RAKE receiver can be expressed as
$${\hat{y}}_{E , {\{ k \}}_{n}}^{p} = ID \{ {r}_{k - ( 1 / 2 ) - p} \times {c}_{{\vert k \vert}_{N}} \}$$
and
$${\hat{y}}_{L , {\{ k \}}_{n}}^{p} = ID \{ {r}_{k - ( 1 / 2 ) - p} \times {c}_{{\vert k - 1 \vert}_{N}} \}$$
it needs to be noted that said I/D latency n is an important design parameter, it represents coherent integration duration used by said I/D filtering operation, as a result, it has to be kept shorter than said processing gain M in order to avoid any possibility of data sign inversion effects, in other words, said I/D filters in EB-, LB- and CB-MPIR must have bandwidth wide enough to accommodate data modulation effects, however, said coherent integration duration also has to be long enough to accurately estimate channel effects, to reject undesired noise, and to effectively regenerate/cancel multipath interference, since said I/D filtering operation takes n chip durations to perform multipath interference regeneration, said incoming streams of said early-, late-, and central-branch correlators have to be delayed for a sake of I/D latency so that multipath interference cancellation can be performed in a correct phase before cross correlation extraction is performed.

5. The modified PN code tracking loop for direct-sequence spread-spectrum communication over arbitrarily correlated multipath fading channels of claim 1, wherein among a front, back and middle correlators, MPI from a nearby path is subtracted with delayed integer-instant samples and delayed half integer-instant samples before cross correlation with a local PN series (i.e., ^{{r}^{ₖ₋ₙ}^{}and {r}^{_{k-(1/2)-n}}^{}}); therefore, a cross correlation on a pth front, back and middle correlator is:
uₖ^{p}, v_{E,k}^{p}, and v_{L,k}^{p}, as:
$${u}_{k}^{p} = \{ [ {r}_{k - p - n} - ( {\hat{z}}_{{\{ k - n \}}_{n}}^{p - 1} + {\hat{z}}_{{\{ k - n \}}_{n}}^{p + 1} ) \times {c}_{{\vert k - n \vert}_{N}} ] \times {c}_{{\vert k - n \vert}_{N}} \} ⊗ {h}_{k} , \\ {v}_{E , k}^{p} = \{ [ {r}_{k - ( 1 / 2 ) - p - n} - ( {\hat{y}}_{E , {\{ k - n \}}_{n}}^{p - 1} + {\hat{y}}_{E , {\{ k - n \}}_{n}}^{p + 1} ) \times {c}_{{\vert k - n \vert}_{N}} ] \times {c}_{{\vert k - n \vert}_{N}} \} ⊗ {h}_{k}$$
and
$${v}_{L , k}^{p} = \{ [ {r}_{k - ( 1 / 2 ) - p - n} - ( {\hat{y}}_{L , {\{ k - n \}}_{n}}^{p - 1} + {\hat{y}}_{L , {\{ k - n \}}_{n}}^{p + 1} ) \times {c}_{{\vert k - 1 - n \vert}_{N}} ] \times {c}_{{\vert k - 1 - n \vert}_{N}} \} ⊗ {h}_{k}$$
\mathring{×} denotes a convolution operator; hₖ is an impulse response function of a first-order low-pass filter, a transfer function of said filter is H(Z)=(1−b)/(1−bZ⁻¹), b=exp(−2πB_{b}T_{c}) having bandwidth B_{b} comparable with a symbol rate 1/T, data modulation effect and channel fading effect on v_{E,k}^{p} and v_{L,k}^{p} need to be compensated for by multiplying them with a complex conjugate of uₖ^{p}, in addition, uₖ^{p} can effectively keep an error characteristic on each RAKE finger within a range [−T_{c},T_{c}] in order to reduce a self-interference effect, therefore, an resultant error signal of said proposed technique called a modified code tracking loop with multipath interference cancellation (MCTL/MPIC) for simplicity can be obtained by means of maximum ratio combining (MRC) criterion and expressed as
$$\begin{matrix}{e}_{k}^{MCTL / MPIC} = {R}_{e} \{ {\sum }_{∀ p} {e}_{k}^{p} \} \\ = {R}_{e} \{ {\sum }_{∀ p} {( {u}_{k}^{p} )}^{*} \cdot ( {v}_{E , k}^{p} - {v}_{L , k}^{p} ) \}\end{matrix}$$
where (•)* denotes as an expression of complex conjugate, after said expression, an error signal (where εₖ=ε) of MCTL/MPIC is revised as:
eₖ^{MCTL/MPIC}=(5Γ₀−8Γ₁+4Γ₂−Γ₃)·S₁(ε)^{+(3Γ}^{₀}^{-6Γ}^{₁}^{+5Γ}^{₂}^{-3Γ}^{₃}^{Γ}^{₄}^{)·S}^{₂}^{(ε)}+(5Γ₀−8Γ₁+4Γ₂−Γ₃)·S₃(ε) (7)
where
$${S}_{1} ( ϵ ) = g ( ϵ {T}_{c} ) \{ g [ ( ϵ - \frac{1}{2} ) {T}_{c} ] - g [ ( ϵ + \frac{1}{2} ) {T}_{c} ] \}$$
$${S}_{2} ( ϵ ) = g [ ( ϵ - 1 ) {T}_{c} ] g [ ( ϵ + \frac{1}{2} ) {T}_{c} ] - g [ ( ϵ + 1 ) {T}_{c} ] g [ ( ϵ - \frac{1}{2} ) {T}_{c} ]$$
$${S}_{3} ( ϵ ) = g [ ( ϵ + 1 ) {T}_{c} ] g [ ( ϵ + \frac{1}{2} ) {T}_{c} ] - g [ ( ϵ - 1 ) {T}_{c} ] g [ ( ϵ - \frac{1}{2} ) {T}_{c} ]$$
$${Γ}_{0} = {\sum }_{∀ p} {‖ {a}_{p} ‖}^{2}$$
$${Γ}_{1} = {\sum }_{∀ p} Re \{ {a}_{p} {a}_{p + 1}^{*} \}$$
$${Γ}_{2} = {\sum }_{∀ p} Re \{ {a}_{p} {a}_{p + 2}^{*} \}$$
$${Γ}_{3} = {\sum }_{∀ p} Re \{ {a}_{p} {a}_{p + 3}^{*} \}$$
$$and$$
$${Γ}_{4} = {\sum }_{∀ p} Re \{ {a}_{p} {a}_{p + 4}^{*} \}$$
it needs to be noted that Γ₀, Γ₁, Γ₂, Γ₃, Γ₄ all vary over time with variation of channel effects, though no apparent symbol k or t is employed here, if αₗ, ∀ₗ, are independent complex Gaussian random variables with zero means, then an error characteristic (i.e., so-called S-curve) can be further formulated as
S^{MCTL/MPIC}(ε)=<E{Γ₀}>[5S₁(ε)+3S₂(ε)+5S₃(ε)] (8)
where<•>and E{•}denote time-average and expectation operations, respectively, no matter what kind of combination of channel tap weights αₗ, ∀ₗ (say, uncorrelated, correlated or arbitrarily correlated with time-varying cross correlations among multiple propagation paths), is considered, both error signal and S-curve of MCTL/MPIC have been proven to be definitely odd-symmetric with respect to their common locked point at ε=0 because S₁(ε), S₂(ε), and S₃(ε) all have this property.

6. The modified PN code tracking loop for direct-sequence spread-spectrum communication over arbitrarily correlated multipath fading channels of claim 1, wherein an error message whose structure differs from MPIC is called MCTL can be recalculated and presented as:
$$\begin{matrix}{e}_{k}^{MCTL} = Re \{ {\sum }_{∀ p} {( {u}_{k}^{- p} )}^{*} ( {v}_{E , k}^{- p} - {v}_{L , k}^{- p} ) \} \\ = ( {Γ}_{0} - {Γ}_{1} ) {S}_{1} ( ϵ ) + ( {Γ}_{2} - {Γ}_{1} ) {S}_{2} ( ϵ ) + ( {Γ}_{0} - {Γ}_{1} ) {S}_{3} ( ϵ )\end{matrix}$$
=(Γ₀−Γ₁)S₁(ε)+(Γ₂−Γ₁)S₂(ε)+(Γ₀−Γ₁)S₃(ε)
where
$${u}_{k}^{- p} = \{ {r}_{k - p - n} \times {c}_{{\vert k - n \vert}_{N}} \} ⊗ {h}_{k} , \\ {v}_{E , k}^{- p} = \{ {r}_{k - ( 1 / 2 ) - p - n} \times {c}_{{\vert k - n \vert}_{N}} \} ⊗ {h}_{k} , \\ {v}_{L , k}^{- p} = \{ {r}_{k - ( 1 / 2 ) - p - n} \times {c}_{{\vert k - 1 - n \vert}_{N}} \} ⊗ {h}_{k} .$$
if its channel tap weight is zero-mean and independent from each other, then S curve of MCTL is revised as:
S^{MCTL}(ε)=<E{Γ₀}>[S₁(ε)+S₃(ε)].
both error signal and S-curve of MCTL/MPIC have been proven to be definitely odd-symmetric with respect to their common locked point at ε=0, under an assumption where its channel tap weight equals to zero-mean and is independent from each other, said RAKE finger is still under an influence of self-interference from a nearby RAKE finger.

7. The modified PN code tracking loop for direct-sequence spread-spectrum communication over arbitrarily correlated multipath fading channels of claims 4 and 5, wherein said error signal and error signal featuring curve of time-varying multi-path channel possesses a stable and unique locked points and odd-symmetric error signal featuring curve, proving an absolute astringent, stable tasking and strong pull-in capability of MCTL.
